(19) United States
(12) Patent Application Publication
(10) Pub. No.: US 2010/0323773 A1
(43) Pub. Date: Dec. 23, 2010

(54) Imprint Collecting Device and Method of Manufacturing Same

(75) Inventor: Jeffrey William Ross, Uxbridge (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(73) Assignee: JEFFREY ROSS JEWELLERY LTD., Uxbridge (CA)

(21) Appl. No.: 12/489,659

(22) Filed: Jun. 23, 2009

(51) Int. Cl. B41L 3/12; B23P 11/00

(52) U.S. Cl. 462/1; 283/78; 29/428

(57) ABSTRACT

The present invention relates to an imprint collecting device used to collect imprints such as fingerprints for use in applications such as manufacturing personalized decorative items such as jewelry, and to methods of manufacturing the imprint collecting device.

### FIELD OF THE INVENTION

The present invention relates to an imprint collecting device for collecting imprints such as fingerprints which can be employed in applications such as the creation of personalized decorative items. The invention further relates to methods of manufacturing said imprint collecting device.

### BACKGROUND OF THE INVENTION

Personalized decorative items and mementos such as jewelry, charms, keychains and the like, have recently been gaining in popularity with consumers. One means of personalizing items has been with permanent representations of fingerprints. For instance, many parents of young children or infants wish to capture a representation of their child's fingerprints, and have these impressions preserved and incorporated into jewelry, such as charms, made of precious or semi-precious metals. Persons may also wish to capture and use representations of adult fingerprints in the same manner. As well, many wish to have preserved imprints of an infant or child's appendage such as a hand or foot, or even pawprints of beloved pets such as dogs and cats.

Such personalized jewelry or other decorative items may be created in accordance with known methods. For instance, fingerprints can be taken by pressing the subject's finger into wax, followed by the creation of a mold which is ultimately used to cast the fingerprint impression into relief on a permanent object. There is also a specialized type of clay commercially available known as metal clay, which can itself be fired in a kiln after an impression is taken, and then incorporated into the decorative object or jewelry without the need for creating a mold.

The collection of imprints for the above purpose is a process with some inherent difficulties and inconveniences. A principal difficulty has been the necessity for the subject who is providing an imprint to attend in person at the site of the jeweler or other professional who is to receive the impression in the wax or clay. This has been necessary as there has never existed in the field an inexpensive container that can be used to ship a quantity of deformable material such as clay that will keep the clay malleable until it is deformed with a three-dimensional impression, and also keep the impression intact during shipment to the jeweler. The difficulties with designing such a container have centred around the fact that adequate air space must be provided in such a container to accommodate the three-dimensional impression, and to preserve the impression so that it arrives safely at the jeweler. However, allowing too much space in the container will be problematic because the clay can shift during shipment with damage resulting to the three-dimensional impression. As well, clay is a humid substance that is highly susceptible to rapid moisture loss in the presence of even a small volume of air. Moisture lost from the clay tends to condense on the inside of the container, and the clay dries out. Once the clay dries out, an accurate impression of the delicate features of a fingerprint cannot be captured.

What is needed is an inexpensively constructed, shippable container for a deformable material such as clay which will prevent the clay from drying out prior to use, and which can be used to ship the deformed clay, all while protecting the integrity of the imprint.

### SUMMARY OF THE INVENTION

The present invention provides an imprint collecting device which contains a sufficient quantity of clay to receive a three-dimensional impression of an imprint, said device having a lid, a recess into which the clay is inserted, and a seal for covering the surface of the clay in the container.

In one embodiment the present invention provides a quantity of metal clay which is pressed into a disk and inserted into a recess of a plastic tray with a hinged lid. The clay is covered with a protective seal made of wax that has been sprayed with a non-stick silicone spray. The wax seal protects the exposed surface of the clay during shipment to a customer, and prevents the clay from drying out. Once the customer has received the container, the lid is opened, the wax seal is removed and discarded, and the impression made. The lid can then be closed. The lid is configured to leave some air space between the lid and the wax seal when closed in the absence of the seal, which serves to protect the integrity of the three-dimensional impression and further allows for additional air to circulate in the container, dry the deformed clay, and further preserve the impression. The impressed clay can then be shipped back in the container, and safely delivered to the jeweler or other professional.

A further aspect of this invention is a manufacturing method for making devices for shipping deformable materials such as clay. A container is preformed to incorporate a recess, and a snugly fitting fold-over lid. A wax seal in the shape of a disk is also preformed to fit the recess of the tray. The tray is placed on the plate of a press such as an arbour press. A quantity of clay is then placed into the recess of the tray, and the ram of the press is lowered onto the clay and pressure applied to form the clay into a malleable, flat disk with a smooth surface. The wax seal is sprayed with a lubricating spray, and placed, coated side down, onto the disk of clay. The lid of the tray is then folded over and closed to secure the disk of clay in place.

Yet a further aspect of this invention is a kit including the imprint collecting device described above, which can be mailed to the consumer. The kit is accompanied by written directions that instruct the consumer in the use of the imprint collecting device.

### BRIEF DESCRIPTION OF THE DRAWINGS

The present invention will now be better understood with reference to the description and to the accompanying drawings in which:

FIG. 1 is a side perspective view of an exemplary embodiment of the imprint collecting device in accordance with one aspect of the invention.

FIG. 2 is an front elevation view of the imprint collecting device from the viewpoint indicated by the numeral 2 in FIG. 1.

FIG. 3 is a cross-sectional side view of the imprint collecting device taken along the line indicated by the numeral 3 in FIG. 1.

FIG. 4 is a side perspective view of an exemplary embodiment of the imprint collecting device with the lid opened.

### DETAILED DESCRIPTION OF THE PREFERRED EMBODIMENTS

The present invention provides an imprint collecting device comprising a sufficient quantity of deformable material such as clay to receive a three-dimensional impression of an imprint such as a fingerprint, said container having a lid, a recess into which the clay is inserted, and a seal for covering the surface of the clay in the container. The device of the present invention maintains the moisture necessary to preserve the deformable material so that it is kept sufficiently malleable until use. After the material receives a three dimensional impression, the device safely contains and protects the impression in the deformable material until it has been sent to the jeweler and a permanent representation of the impression captured as part of a personalized decorative object.

As set out above, one feature of the device of the invention is that the moisture is maintained in the deformable material prior to use. A number of experiments were conducted using metal clay in combination with different substances and configurations further to developing the device of the present invention. Various configurations were attempted in an effort to increase or control the ambient humidity in the containers. The results obtained with alternate configurations are summarized in Table 1 below. As set out in Table 1, until the invention described herein was developed, numerous problems were encountered including evaporation of moisture out of the clay, and loss of malleability.

TABLE 1

| Test Combination | Moisture Retention | Clay Malleability |
|---|---|---|
| Clay alone (control) | Moisture condensed on surface of clay | Decreased malleability |
| | and on interior of lid | |
| Clay + drop of distilled water | Moisture condensed on surface of clay | Decreased malleability |
| | and on interior of lid | |
| Clay + moist towellette* | Moisture condensed on surface of clay | Decreased malleability |
| | and on interior of lid | |
| Clay + acetate film cover | Moisture condensed on interior of lid | Decreased malleability |
| Clay + acetate film cover + moist | Moisture condensed on interior of lid | Decreased malleability |
| towellette | | |
| Clay + drop of mineral oil | Moisture condensed on interior of lid | Decreased malleability |
| Clay + drop of mineral oil + acetate | Moisture condensed on interior of lid | Acceptable malleability |
| film cover | | |
| Clay + plastic cling film cover | Moisture condensed on interior of lid | Decreased malleability |
| Clay + drop of mineral oil + plastic | No condensation | Inconsistent impact on |
| cling film cover | | malleability |
| Clay + silicone seal with flange | No condensation | Decreased malleability |
| Clay + silicone seal without flange | No condensation | Decreased malleability |
| Clay + wax seal with flange + drop | Condensation on clay surface | Decreased malleability |
| mineral oil | | |
| Clay + drop of distilled water + | Condensation on clay surface | Acceptable malleability |
| wax seal with flange | | |
| Clay + Castaldo ™ release spray + | No condensation | Retained malleability |
| wax seal with flange | | |

All samples were sealed and placed in age-testing incubator, model 1510E, manufactured by VWR Scientific Products. According to the manufacturer, 24 hours in this incubator at 125 F. is equivalent to 52 days of aging at ambient temperatures.
All samples were aged in the incubator for 24 hours, which was maintained at a temperature of 125 F.
*moist towellette used was WET-NAP ™ brand.

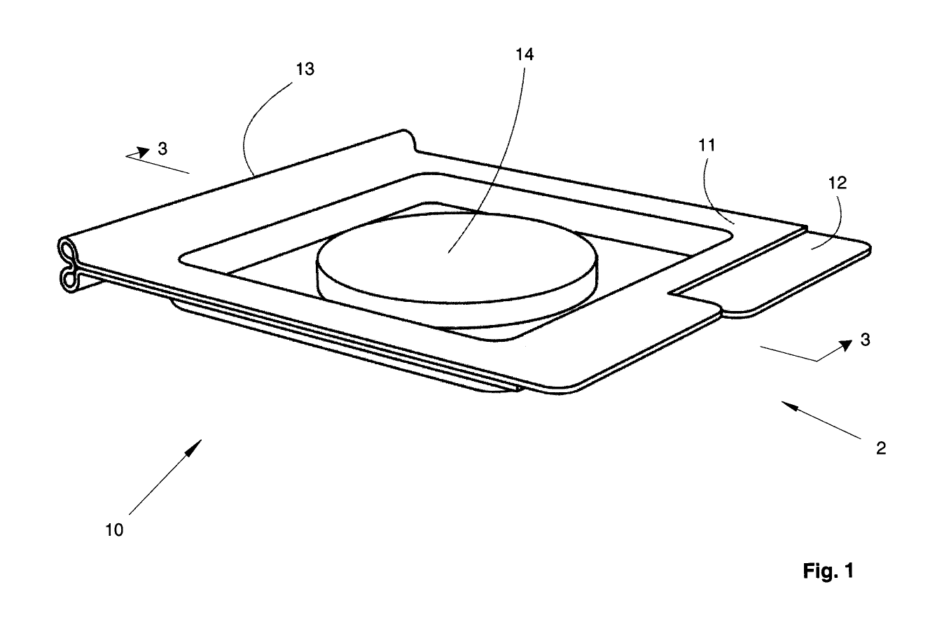

The imprint collecting device of the invention will now be described in further detail with reference to FIGS. 1 through 4 in which the imprint collecting device is indicated generally at numeral 10.

FIG. 1 shows one embodiment of the imprint collecting device 10, which comprises a recessed tray 11 attached to a lid 12 by way of hinge 13. Lid 12 is secured shut against recessed tray 11 by the application of light pressure.

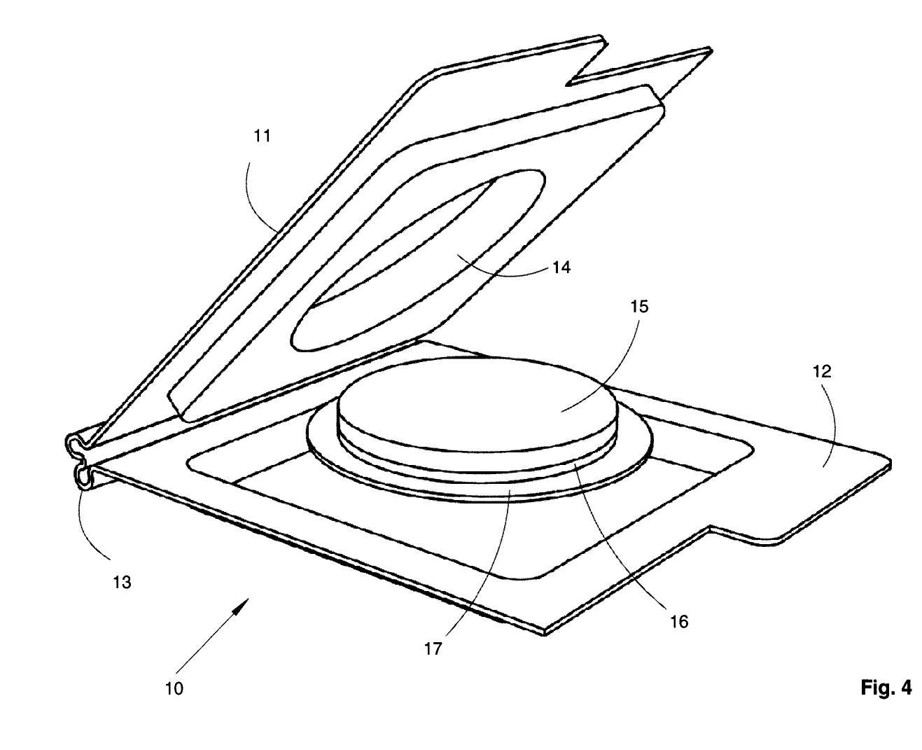

Recessed tray 11 also incorporates recess 14, depicted as circular in this embodiment, into which a quantity of deformable material 15 (see FIGS. 3 and 4) is inserted. If the impression will be a fingerprint, it has been found that a diameter of 23 mm and a depth of 3 mm for recess 14 are suitable dimensions. A suitable quantity of deformable material 15 for a single fingerprint is 5 g. However, this invention should not be considered to be limited to the stated dimensions. Different dimensions for recess 14 may be used, and amounts of deformable material 15 may be varied depending on the intended use. For instance, larger dimensions for recessed tray 11 and recess 14, and a larger quantity of deformable material 15, are needed if an impression will be taken of an appendage such as a hand, foot, or paw.

A convenient material for fabricating recessed tray 11 and lid 12 is PVC (polyvinyl chloride). Recessed tray 11 and lid 12 can be manufactured by standard procedures such as thermoforming or injection molding.

A suitable deformable material is a specialized type of clay known commonly as metal clay. It is available commercially from a number of companies, including Mitsubishi Materials™ under the brand name PMC™ (Precious Metal Clay) and from Aida Chemicals™ under the brand name ART CLAY SILVER™. However, other deformable materials may be used in place of metal clay, such as wax, putty, or other types of clay.

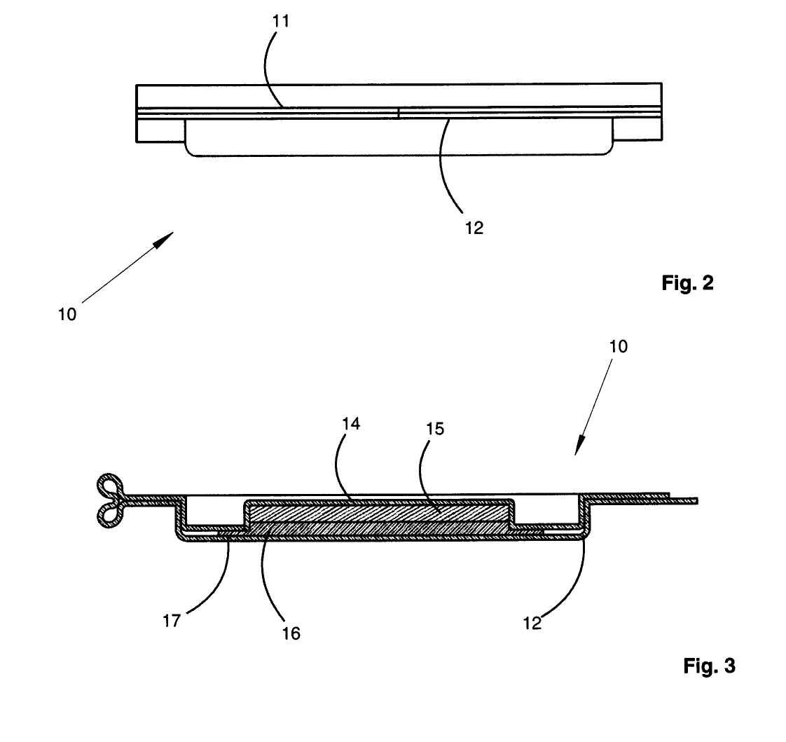

FIG. 2 shows a front elevation view of imprint collecting device 10, and displays the interlocking of recessed tray 11 and lid 12 when closed.

FIG. 3 shows a cross-sectional side view of imprint collecting device 10. Recessed tray 11 contains a quantity of deformable material 15 inserted into recess 14. A seal 16 is placed on the exposed side of deformable material 15, and secured in place with the closing of lid 12. Seal 16 includes a flange 17 of larger diameter than recess 14. Flange 17 provides additional protection against moisture loss from deformable material 15. Seal 16 of the depicted embodiment may be formed of specialized wax known as jewelry wax, commercially available under the trade name FREEMAN™.

As will be appreciated from FIG. 3, if seal 16 has been removed and lid 12 is secured shut against recessed tray 11, there remains an interior space between the rim of recess 14 and lid 12. This interior space is incorporated so as to accommodate any raised surfaces of deformable material 15 following an imprint being taken. In an embodiment which is dimensioned for accommodating a single fingerprint, the interior space may be approximately 1 mm in height.

FIG. 4 shows a perspective view of imprint collecting device 10 with recessed tray 11 and lid 12 opened in relation to each other at hinge 13. Clearly seen are recess 14, into which deformable material 15 will be inserted when the device is closed, and the exposed surface of which will be covered by seal 16, which incorporates flange 17.

A method for manufacturing imprint collecting device 10 of the present invention is also disclosed. Recessed tray 11 may be preformed to incorporate recess 14, and lid 12. Seal 16 may also be preformed with flange 17 to fit recess 14 of recessed tray 11. Lid 12 may be raised from recessed tray 11 to expose recess 14, and recessed tray 11 may then be placed, with recess 14 facing upwards, onto the press plate of a press such as an arbour press. A quantity of deformable material 15 may then be placed into recess 14 of the tray, and the ram of the press lowered onto deformable material 15 and pressure applied to press deformable material 15 into a malleable, flat disk with a smooth surface. Seal 16 may be sprayed with a non-stick spray such as the jewelry mold release spray commercially available under the brand CASTALDO™. Seal 16 may then be placed so that the sprayed side is adjacent to the exposed surface of the disk of deformable material 15. Lid 12 may then be folded over and closed against recessed tray 11 to secure seal 16 in place.

Alternately, deformable material 15 may not require pressing if said deformable material 15 is provided in an amount appropriate to fit recess 14, or if said deformable material 15 is placed into recess 14 by a method such as extrusion. As well, seal 16 may be made of other materials that may not require a non-stick spray coating. Other possible materials for seal 16 are substantially moisture proof sheet materials such as foil laminate, paper laminate, or a barrier plastic. If such sheet materials are used for seal 16, they can be pre-cut to a size in excess of perimeter of recess 14, to allow seal 16 to be attached to perimeter of recess 14 by means such as adhesive or heat sealing.

Following its manufacture, imprint collecting device 10 may then optionally be inserted into a foil pouch or envelope (not shown) and sealed therein, using adhesive or a standard heat sealing press. A favoured material used for the foil pouch is a barrier material that is substantially resistant to the passage of moisture and air, such as a layered barrier material which includes PET (polyethylene terephthalate), foil, and LLDPE (linear low density polyethylene). It is additionally beneficial if the foil pouch material has a printable surface and incorporates tear notches for easy opening.

Further, a kit incorporating the imprint collecting device 10 of the present invention to obtain an imprint is also disclosed. Such a kit includes imprint collecting device 10 and written instructions which direct a user in the method of employing imprint collecting device 10. The user is instructed to remove seal 16, impress the object to be imprinted into deformable material 15, close lid 12 on recessed tray 11, and send imprint collecting device 10 to a specified professional for processing. Upon receipt, the professional may then immediately employ the imprint captured in deformable material 15 to create a personalized decorative item incorporating the imprint.

The invention described herein is a practical and inexpensive way of remotely obtaining imprints for use in the creation of jewelry and other decorative items. The invention preserves the moisture in the clay until a three-dimensional impression is taken, and then protects the integrity of that three-dimensional impression until it is received by a jeweler. The invention is simple to manufacture and use, and is expected to permit the creation of personalized decorative items on a wider commercial scale than has been previously permitted due to the limitations of the existing technology and processes.

While the invention has been described with reference to specific embodiments thereof, it will be appreciated that numerous variations, modifications, and embodiment are possible. For instance, while metal clay is described as the deformable material in the preferred embodiment, any number of other deformable substances such as wax, putty, or the like could be used in place of metal clay. Accordingly, all such variations, modifications and embodiments are to be regarded as being within the spirit and scope of the invention.

1. An imprint collecting device, comprising:
deformable material having a surface;
a container comprising:
a tray having a recess, the recess for holding the deformable material so that when the deformable material is held in the recess at least a portion of the surface of the deformable is exposed; and
a lid for covering the tray; and
a seal removably securable over the exposed surface of the deformable material in the recess.

2. The imprint collecting device of claim 1, in which
the deformable material is provided in a quantity sufficient to receive a three-dimensional impression of a fingerprint.

3. The imprint collecting device of claim 1, in which
the deformable material is provided in a quantity sufficient to receive a three-dimensional impression of an appendage.

4. The imprint collecting device of claim 1, further comprising:
an envelope of substantially moisture-proof material into which the container is sealed.

5. The imprint collecting device of claim 1, in which
the deformable material is clay.

6. The imprint collecting device of claim 1, in which
the seal is provided with a non-stick coating prior to covering the exposed surface of the deformable material.

7. The imprint collecting device of claim 1, in which
the recess is circular.

8. The imprint collecting device of claim 1, in which
the container is formed from polyvinyl chloride.

9. The imprint collecting device of claim 1, in which
the seal is formed from a substantially moisture-proof material.

10. The imprint collecting device of claim 9, in which
the substantially moisture-proof material is wax.

11. The imprint collecting device of claim 9, in which
the substantially moisture-proof material is plastic.

12. The imprint collecting device of claim 9, in which
the substantially moisture-proof material is a foil laminate.

13. The imprint collecting device of claim 9, in which
the substantially moisture-proof material is a paper laminate.

14. A method of manufacturing an imprint collecting device according to claim 1, comprising the steps of:
providing the container;
providing the seal;
inserting the deformable material into the recess;
removably securing the seal over the exposed surface of the deformable material; and
closing the lid of the container.

15. A method of manufacturing an imprint collecting device according to claim 14, further incorporating the step of:
pressing the deformable material into the recess.

16. A method of manufacturing an imprint collecting device according to claim 14, further incorporating the steps of:
coating the seal with lubricating spray; and
arranging the seal over the surface of the deformable material such that a lubricated surface of the seal is directly adjacent to the exposed surface of the deformable material.

17. A method of manufacturing an imprint collecting device according to claim 14, further incorporating the steps of:
adhering the seal to the perimeter of the recess.

18. An imprint collecting kit, comprising:
an imprint collecting device of claim 1;
instructions directing a user to:
remove the seal;
impress an object to be imprinted into the deformable material;
close the lid of the container; and
send the imprint collecting device to a provided location.
